(19) United States
(12) Patent Application Publication
(10) Pub. No.: US 2024/0414808 A1
(43) Pub. Date: Dec. 12, 2024

(54) RESOURCE SELECTION CONSIDERING SIDELINK DRX

(71) Applicant: Lenovo (Singapore) Pte. Ltd., New Tech Park (SG)

(72) Inventors: Karthikeyan Ganesan, Kronberg im Taunus (DE); Prateek Basu Mallick, Dreieich (DE)

(21) Appl. No.: 18/702,672

(22) PCT Filed: Oct. 18, 2022
(86) PCT No.: PCT/IB2022/060008

§ 371 Date: Apr. 18, 2024

Related U.S. Application Data
(60) Provisional application No. 63/257,002, filed on Oct. 18, 2021.

(51) Int. Cl. H04W 76/28; H04W 72/0446; H04W 72/25

(52) U.S. Cl. CPC H04W 76/28; H04W 72/0446; H04W 72/25

(57) ABSTRACT

Apparatuses, methods, and systems are disclosed for resource selection considering sidelink DRX. An apparatus (800) includes a memory (810) and a processor (805) coupled to the memory (810). The processor (805) is configured to cause the apparatus (800) to determine an event triggering a resource reselection to perform candidate resource selection from 5 a resource pool according to a DRX timer. The processor (805) is configured to cause the apparatus (800) to select, in response to the event triggering the resource reselection, a first candidate resource from the resource pool during an active duration of the apparatus associated with the DRX timer and a second candidate resource from the resource pool during an inactive duration of the apparatus associated with the DRX timer. The processor (805) is configured to 0 cause the apparatus (800) to transmit a report indicating the first candidate resource and the second candidate resource.

### CROSS-REFERENCE TO RELATED APPLICATIONS

This application claims priority to U.S. Provisional Patent Application No. 63/257,002 entitled “EFFICIENT RESOURCE SELECTION CONSIDERING SIDELINK DRX MECHANISM” and filed on Oct. 18, 2021, for Karthikeyan Ganesan, et al., which is incorporated herein by reference.

### FIELD

The subject matter disclosed herein relates generally to wireless communications and more particularly relates to resource selection considering sidelink (“SL”) discontinuous reception (“DRX”).

### BACKGROUND

In some wireless communication networks, a user equipment (“UE”) may support DRX operation for power saving. The UE may exchange information (e.g., configuration, assistance information, etc.) to enable communication (e.g., transmission, reception, transfer) of data during the DRX operation. For example, the UE may be configured by a network entity (e.g., a base station) with a DRX configuration, which indicates active and inactive durations (also referred to as ON durations and OFF durations). An active duration may be a period in which the UE is operating in a normal power mode, while an inactive duration may be a period in which the UE is operating in a low power mode (also referred to as a low power state). In the inactive duration, the UE may power OFF one or more components (e.g., a receiver, a transmitter, or other hardware) to conserve power. Although DRX operation provides power saving benefits for the UE, it may be desirable to evaluate further power saving aspects of the DRX operation related to different protocol layers of the UE and, specifically, related to a physical (“PHY”) layer of the UE and applying restrictions for resource selection during DRX operation.

### BRIEF SUMMARY

Disclosed are solutions for resource selection considering sidelink DRX. The solutions may be implemented by apparatus, systems, methods, or computer program products.

In one embodiment, a first apparatus includes a memory and a processor coupled to the memory. In one embodiment, the processor is configured to cause the apparatus to determine an event triggering a resource reselection to perform candidate resource selection from a resource pool according to a DRX timer. In one embodiment, the processor is configured to cause the apparatus to select, in response to the event triggering the resource reselection, a first candidate resource from the resource pool during an active duration of the apparatus associated with the DRX timer and a second candidate resource from the resource pool during an inactive duration of the apparatus associated with the DRX timer. In one embodiment, the processor is configured to cause the apparatus to transmit a report indicating the first candidate resource and the second candidate resource.

In one embodiment, a first method determines, at a UE, an event triggering a resource reselection to perform candidate resource selection from a resource pool according to a DRX timer. In one embodiment, the first method selects, in response to the event triggering the resource reselection, a first candidate resource from the resource pool during an active duration of the UE associated with the DRX timer and a second candidate resource from the resource pool during an inactive duration of the UE associated with the DRX timer. In one embodiment, the first method transmits a report indicating the first candidate resource and the second candidate resource.

In one embodiment, a second apparatus includes a memory and a processor coupled to the memory. In one embodiment, the processor is configured to cause the apparatus to transmit, to a UE, a resource reselection trigger to perform candidate resource selection from a resource pool according to a DRX timer. In one embodiment, the processor is configured to cause the apparatus to receive a report comprising a selection of a first and second selected candidate resources selected from the resource pool, the first candidate resource selected during an active duration of the UE associated with the DRX timer, and the second candidate resource selected pool during an inactive duration of the UE associated with the DRX timer.

In one embodiment, a second method transmits, to a UE, a resource reselection trigger to perform candidate resource selection from a resource pool according to a DRX timer. In one embodiment, the second method receives a report comprising a selection of a first and second selected candidate resources selected from the resource pool, the first candidate resource selected during an active duration of the UE associated with the DRX timer, and the second candidate resource selected pool during an inactive duration of the UE associated with the DRX timer.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for resource selection considering sidelink DRX;

FIG. 2 depicts an example PHY layer:

FIG. 3 depicts a DRX configuration as part of the resource (re) selection trigger:

FIG. 4 depicts a resource (re) selection trigger containing inactivity timer:

FIG. 5 depicts a resource (re) selection trigger considering each DRX on-duration timer:

FIG. 6 depicts a resource (re) selection considering one or more DRX on-duration periods:

FIG. 7 is a diagram illustrating one embodiment of a new radio (“NR”) protocol stack:

FIG. 8 is a block diagram illustrating one embodiment of a UE apparatus that may be used for resource selection considering sidelink DRX:

FIG. 9 is a block diagram illustrating one embodiment of a network equipment apparatus that may be used for resource selection considering sidelink DRX:

FIG. 10 is a flowchart diagram illustrating one embodiment of a method for resource selection considering sidelink DRX; and

FIG. 11 is a flowchart diagram illustrating one embodiment of a method for resource selection considering sidelink DRX.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising.” “having.” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatuses for efficient resource selection considering sidelink DRX. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

In NR Rel17, there is a discussion about whether/how PHY layer applies restrictions for resource selection with DRX active time of Rx UE, including the following options:
Option 1: PHY layer selects and reports candidate resources only within active time of the Rx UE;
Option 2: PHY layer selects and reports candidate resources in which at least a subset of the candidate resources is within active time of the Rx UE; and/or
Option 3: PHY layer selects and reports an additional candidate resource set which includes candidate resources within active time of the Rx UE.

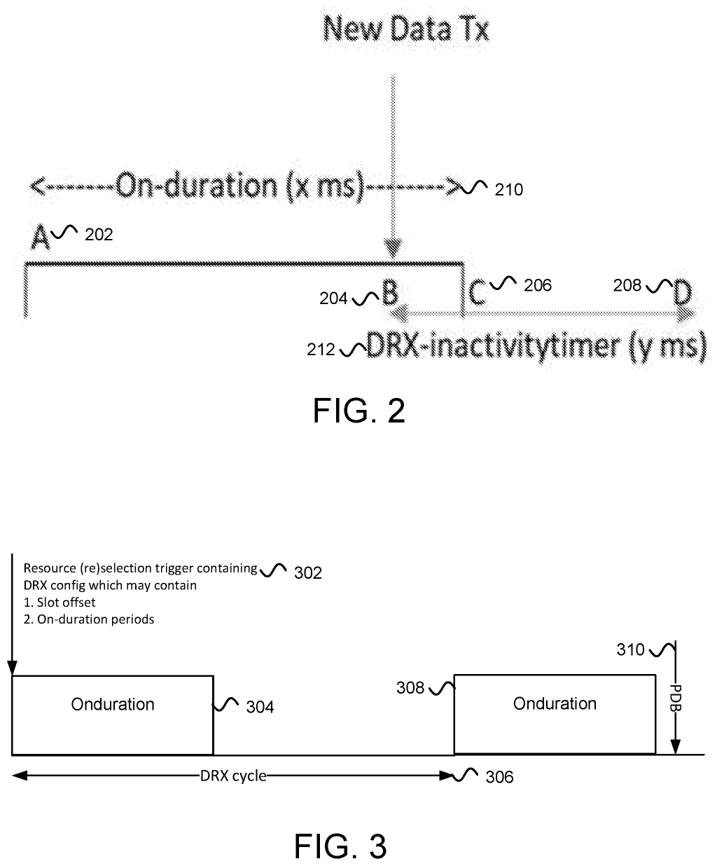

As shown in FIG. 2, if the medium access control (“MAC”) gives time between A 202 and D 208 to PHY, then PHY might select resources between C 206 and D 208, which will create a problem since the Rx is sleeping during this time as it did not start an inactivity timer (since PHY did not select resources within A 202 and C 206). In FIG. 2, Current Active time=time between points A 202 and C 206 (e.g., the on-duration timer 210) and Future Active time=time between points C 206 and D 208 (e.g., a part of the inactivity timer 212 hanging outside on-duration timer).

An issue may be that the MAC cannot provide A 202 to D 208 (e.g., active time in RAN2 agreement) as an input to the PHY resource selection because it does not know whether it will start the inactivity timer in advance.

DRX active time on-duration timer is constant and periodic while the retransmission, inactivity timer may be dynamically started based on an event. In this disclosure, multiple options are considered to trigger resource (re) selection from a higher layer by including a DRX active time to report candidate resources within the active time.

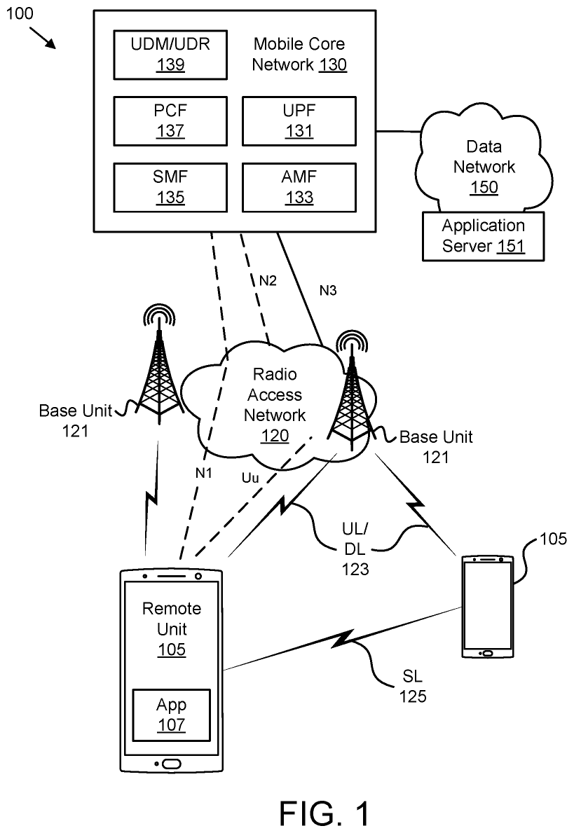

Referring now to FIG. 1, FIG. 1 depicts a wireless communication system 100 supporting resource selection considering sidelink DRX, according to embodiments of the disclosure. In one embodiment, the wireless communication system 100 includes at least one remote unit 105, a radio access network (“RAN”) 120, and a mobile core network 130. The RAN 120 and the mobile core network 130 form a mobile communication network. The RAN 120 may be composed of a base unit 121 with which the remote unit 105 communicates using wireless communication links 115. Even though a specific number of remote units 105, base units 121, wireless communication links 115, RANs 120, and mobile core networks 130 are depicted in FIG. 1, one of skill in the art will recognize that any number of remote units 105, base units 121, wireless communication links 115, RANs 120, and mobile core networks 130 may be included in the wireless communication system 100.

In one implementation, the RAN 120 is compliant with the 5G system specified in the Third Generation Partnership Project (“3GPP”) specifications. For example, the RAN 120 may be a New Generation Radio Access Network (“NG-RAN”), implementing NR RAT and/or 3GPP Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. Furthermore, the UL and DL communication signals may be carried over the wireless communication links 123. Here, the RAN 120 is an intermediate network that provides the remote units 105 with access to the mobile core network 130. In one embodiment, the remote units 105 communicate directly with one another via a sidelink (“SL”) connection 125. As used herein, sidelink is a core topology of the 5G system design that enables direct communication between two devices without the participation of a base station in the transmission and reception of data traffic.

In some embodiments, the remote units 105 communicate with an application server via a network connection with the mobile core network 130. For example, an application 107 (e.g., web browser, media client, telephone and/or Voice-over-Internet-Protocol (“VOIP”) application) in a remote unit 105 may trigger the remote unit 105 to establish a protocol data unit (“PDU”) session (or other data connection) with the mobile core network 130 via the RAN 120. The mobile core network 130 then relays traffic between the remote unit 105 and the application server (e.g., the content server 151 in the packet data network 150) using the PDU session. The PDU session represents a logical connection between the remote unit 105 and the User Plane Function (“UPF”) 131.

To establish the PDU session (or PDN connection), the remote unit 105 must be registered with the mobile core network 130 (also referred to as ““attached to the mobile core network” in the context of a Fourth Generation (“4G”) system). Note that the remote unit 105 may establish one or more PDU sessions (or other data connections) with the mobile core network 130. As such, the remote unit 105 may have at least one PDU session for communicating with the packet data network 150, e.g., representative of the Internet. The remote unit 105 may establish additional PDU sessions for communicating with other data networks and/or other communication peers.

In the context of a 5G system (“5GS”), the term “PDU Session” a data connection that provides end-to-end (“E2E”) user plane (“UP”) connectivity between the remote unit 105 and a specific Data Network (“DN”) through the UPF 131. A PDU Session supports one or more Quality of Service (“QoS”) Flows. In certain embodiments, there may be a one-to-one mapping between a QoS Flow and a QoS profile, such that all packets belonging to a specific QOS Flow have the same 5G QOS Identifier (“5Q1”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 130. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 130 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR-U operation, the base unit 121 and the remote unit 105 communicate over unlicensed radio spectrum.

In one embodiment, the mobile core network 130 is a 5GC or an Evolved Packet Core (“EPC”), which may be coupled to a packet data network 150, like the Internet and private data networks, among other data networks. A remote unit 105 may have a subscription or other account with the mobile core network 130. Each mobile core network 130 belongs to a single public land mobile network (“PLMN”). The present disclosure is not intended to be limited to the implementation of any particular wireless communication system architecture or protocol.

The mobile core network 130 includes several network functions (“NFs”). As depicted, the mobile core network 130 includes at least one UPF 131. The mobile core network 130 also includes multiple control plane (“CP”) functions including, but not limited to, an Access and Mobility Management Function (“AMF”) 133 that serves the RAN 120, a Session Management Function (“SMF”) 135, a Network Exposure Function (“NEF”), a Policy Control Function (“PCF”) 137, a Unified Data Management function (“UDM”) and a User Data Repository (“UDR”).

The UPF(s) 131 is responsible for packet routing and forwarding, packet inspection, QoS handling, and external PDU session for interconnecting Data Network (“DN”), in the 5G architecture. The AMF 133 is responsible for termination of NAS signaling, NAS ciphering & integrity protection, registration management, connection management, mobility management, access authentication and authorization, security context management. The SMF 135 is responsible for session management (i.e., session establishment, modification, release), remote unit (i.e., UE) IP address allocation & management, DL data notification, and traffic steering configuration for UPF for proper traffic routing.

The NEF is responsible for making network data and resources easily accessible to customers and network partners. Service providers may activate new capabilities and expose them through APIs. These APIs allow third-party authorized applications to monitor and configure the network's behavior for several different subscribers (i.e., connected devices with different applications). The PCF 137 is responsible for unified policy framework, providing policy rules to CP functions, access subscription information for policy decisions in UDR.

The UDM is responsible for generation of Authentication and Key Agreement (“AKA”) credentials, user identification handling, access authorization, subscription management. The UDR is a repository of subscriber information and can be used to service several network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 139.

In various embodiments, the mobile core network 130 may also include an Authentication Server Function (“AUSF”) (which acts as an authentication server), a Network Repository Function (“NRF”) (which provides NF service registration and discovery, enabling NFs to identify appropriate services in one another and communicate with each other over Application Programming Interfaces (“APIs”)), or other NFs defined for the 5GC. In certain embodiments, the mobile core network 130 may include an authentication, authorization, and accounting (“AAA”) server.

In various embodiments, the mobile core network 130 supports different types of mobile data connections and different types of network slices, wherein each mobile data connection utilizes a specific network slice. Here, a “network slice” refers to a portion of the mobile core network 130 optimized for a certain traffic type or communication service. A network instance may be identified by a single-network slice selection assistance information (“S-NSSAI,”) while a set of network slices for which the remote unit 105 is authorized to use is identified by network slice selection assistance information (“NSSAI”).

Here, “NSSAI” refers to a vector value including one or more S-NSSAI values. In certain embodiments, the various network slices may include separate instances of network functions, such as the SMF 135 and UPF 131. In some embodiments, the different network slices may share some common network functions, such as the AMF 133. The different network slices are not shown in FIG. 1 for ease of illustration, but their support is assumed. Where different network slices are deployed, the mobile core network 130 may include a Network Slice Selection Function (“NSSF”) which is responsible for selecting of the Network Slice instances to serve the remote unit 105, determining the allowed NSSAI, determining the AMF set to be used to serve the remote unit 105.

Although specific numbers and types of network functions are depicted in FIG. 1, one of skill in the art will recognize that any number and type of network functions may be included in the mobile core network 130. Moreover, in an LTE variant where the mobile core network 130 comprises an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 133 may be mapped to an MME, the SMF 135 may be mapped to a control plane portion of a PGW and/or to an MME, the UPF 131 may be mapped to an SGW and a user plane portion of the PGW, the UDM/UDR 139 may be mapped to an HSS, etc.

While FIG. 1 depicts components of a 5G RAN and a 5G core network, the described embodiments apply to other types of communication networks and RATs, including IEEE 802.11 variants, Global System for Mobile Communications (“GSM”, i.e., a 2G digital cellular network), General Packet Radio Service (“GPRS”), UMTS, LTE variants, CDMA 2000, Bluetooth, ZigBee, Sigfox, and the like.

In the following descriptions, the term “gNB” is used for the base station but it is replaceable by any other radio access node, e.g., RAN node, eNB, Base Station (“BS”), Access Point (“AP”), NR, etc. Further the operations are described mainly in the context of 5G NR. However, the proposed solutions/methods are also equally applicable to other mobile communication systems supporting resource selection considering sidelink DRX.

As background, as described in TS 38.321-Excerpt NR-Uu: Discontinuous Reception, incorporated herein by reference, the MAC entity may be configured by radio resource control (“RRC”) with a DRX functionality that controls the UE's physical downlink control channel (“PDCCH”) monitoring activity for the MAC entity's cell-radio network temporary identifier (“C-RNTI”), cancellation indication (“CI”)-RNTI, configured scheduling (“CS”)-RNTI, interruption (“INT”)-RNTI, slot format indication (“SFI”)-RNTI, semi-persistent (“SP”)-channel state information (“CSI”)-RNTI, transmit power control (“TPC”)-physical uplink control channel (“PUCCH”)-RNTI, TPC-physical uplink shared channel (“PUSCH”)-RNTI, and TPC-sounding reference signal (“SRS”)-RNTI. When using DRX operation, the MAC entity shall also monitor PDCCH according to requirements found in other clauses of this specification. When in RRC_CONNECTED, if DRX is configured, for all the activated Serving Cells, the MAC entity may monitor the PDCCH discontinuously using the DRX operation specified in this clause; otherwise, the MAC entity shall monitor the PDCCH as specified in TS 38.213, incorporated herein by reference.

RRC controls DRX operation by configuring the following parameters:
drx-onDurationTimer: the duration at the beginning of a DRX Cycle;
drx-SlotOffset: the delay before starting the drx-onDuration Timer;
drx-Inactivity Timer: the duration after the PDCCH occasion in which a PDCCH indicates a new UL or DL transmission for the MAC entity;
drx-RetransmissionTimerDL (per DL hybrid automatic repeat request (“HARQ”) process except for the broadcast process): the maximum duration until a DL retransmission is received;
drx-Retransmission TimerUL (per UL HARQ process): the maximum duration until a grant for UL retransmission is received;
drx-LongCycleStartOffset: the Long DRX cycle and drx-StartOffset which defines the subframe where the Long and Short DRX Cycle starts;
drx-ShortCycle (optional): the Short DRX cycle;
drx-ShortCycleTimer (optional): the duration the UE shall follow the Short DRX cycle;
drx-HARQ-RTT-TimerDL (per DL HARQ process except for the broadcast process): the minimum duration before a DL assignment for HARQ retransmission is expected by the MAC entity;
drx-HARQ-RTT-TimerUL (per UL HARQ process): the minimum duration before a UL HARQ retransmission grant is expected by the MAC entity;
ps-Wakeup (optional): the configuration to start associated drx-onDuration Timer in case DCP is monitored but not detected;
ps-Periodic_CSI_Transmit (optional): the configuration to report periodic CSI during the time duration indicated by drx-onDurationTimer in case DCP is configured but associated drx-onDuration Timer is not started;
ps-TransmitPeriodicLI-RSRP (optional): the configuration to transmit periodic L1-RSRP report(s) during the time duration indicated by drx-onDuration Timer in case DCP is configured but associated drx-onDuration Timer is not started.

When a DRX cycle is configured, the Active Time includes the time while:
drx-onDurationTimer or drx-Inactivity Timer or drx-Retransmission TimerDL or drx-RetransmissionTimerUL or ra-ContentionResolutionTimer (as described in clause 5.1.5) is running: or
a Scheduling Request is sent on PUCCH and is pending (as described in clause 5.4.4); or
a PDCCH indicating a new transmission addressed to the C-RNTI of the MAC entity has not been received after successful reception of a Random Access Response for the Random Access Preamble not selected by the MAC entity among the contention-based Random Access Preamble (as described in clause 5.1.4).

When DRX is configured, the MAC entity shall:
1> if a MAC PDU is received in a configured downlink assignment:
   2> start the drx-HARQ-RTT-TimerDL for the corresponding HARQ process in the first symbol after the end of the corresponding transmission carrying the DL HARQ feedback;
   2> stop the drx-Retransmission TimerDL for the corresponding HARQ process.
1> if a MAC PDU is transmitted in a configured uplink grant:
   2> start the drx-HARQ-RTT-TimerUL for the corresponding HARQ process in the first symbol after the end of the first repetition of the corresponding PUSCH transmission;
   2> stop the drx-Retransmission TimerUL for the corresponding HARQ process.
1> if a drx-HARQ-RTT-TimerDL expires:
   2> if the data of the corresponding HARQ process was not successfully decoded:
      3> start the drx-Retransmission TimerDL for the corresponding HARQ process in the first symbol after the expiry of drx-HARQ-RTT-TimerDL.
1> if a drx-HARQ-RTT-TimerUL expires:
   2> start the drx-Retransmission TimerUL for the corresponding HARQ process in the first symbol after the expiry of drx-HARQ-RTT-TimerUL.
1> if a DRX Command MAC CE or a Long DRX Command MAC CE is received:
   2> stop drx-on Duration Timer;
   2> stop drx-InactivityTimer.
1> if drx-InactivityTimer expires or a DRX Command MAC CE is received:
   2> if the Short DRX cycle is configured:
      3> start or restart drx-ShortCycle Timer in the first symbol after the expiry of drx-Inactivity Timer or in the first symbol after the end of DRX Command MAC CE reception;
      3> use the Short DRX Cycle.
   2> else:
      3> use the Long DRX cycle.
1> if drx-ShortCycleTimer expires:
   2> use the Long DRX cycle.
1> if a Long DRX Command MAC CE is received:
   2> stop drx-ShortCycleTimer;
   2> use the Long DRX cycle.
1> if the Short DRX Cycle is used, and [(SFN×10)+subframe number] modulo (drx-ShortCycle)=(drx-StartOffset) modulo (drx-ShortCycle):
   2> start drx-onDuration Timer after drx-SlotOffset from the beginning of the subframe.
1> if the Long DRX Cycle is used, and [(SFN×10)+subframe number] modulo (drx-LongCycle)=drx-StartOffset:
   2> if DCP is configured for the active DL BWP:
      3> if DCP indication associated with the current DRX Cycle received from lower layer indicated to start drx-onDurationTimer, as specified in TS 38.213: or.
      3> if all DCP occasion(s) in time domain, as specified in TS 38.213, associated with the current DRX Cycle occurred in Active Time considering grants/assignments/DRX Command MAC CE/Long DRX Command MAC CE received and Scheduling Request sent until 4 ms prior to start of the last DCP occasion, or within BWP switching interruption length, or during a measurement gap; or.
      3> if ps-Wakeup is configured with value true and DCP indication associated with the current DRX Cycle has not been received from lower layers:
         4> start drx-onDuration Timer after drx-SlotOffset from the beginning of the subframe.
   2> else:
      3> start drx-onDuration Timer after drx-SlotOffset from the beginning of the subframe.
NOTE 1: In case of unaligned SFN across carriers in a cell group, the SFN of the SpCell is used to calculate the DRX duration.
1> if the MAC entity is in Active Time:
   2> monitor the PDCCH as specified in TS 38.213;
   2> if the PDCCH indicates a DL transmission:
      3> start the drx-HARQ-RTT-TimerDL for the corresponding HARQ process in the first symbol after the end of the corresponding transmission carrying the DL HARQ feedback, regardless of LBT failure indication from lower layers:
NOTE 2: When HARQ feedback is postponed by PDSCH-to-HARQ_feedback timing indicating a non-numerical kl value, as specified in TS 38.213 [6], the corresponding transmission opportunity to send the DL HARQ feedback is indicated in a later PDCCH requesting the HARQ-ACK feedback.
   3> stop the drx-Retransmission TimerDL for the corresponding HARQ process.
   3> if the PDSCH-to-HARQ_feedback timing indicate a non-numerical kl value as specified in TS 38.213 [6]:
      4> start the drx-Retransmission TimerDL in the first symbol after the PDSCH transmission for the corresponding HARQ process.
   2> if the PDCCH indicates a UL transmission:
      3> start the drx-HARQ-RTT-TimerUL for the corresponding HARQ process in the first symbol after the end of the first repetition of the corresponding PUSCH transmission, regardless of LBT failure indication from lower layers:
      3> stop the drx-Retransmission TimerUL for the corresponding HARQ process.
   2> if the PDCCH indicates a new transmission (DL or UL):
      3> start or restart drx-Inactivity Timer in the first symbol after the end of the PDCCH reception.
1> if DCP is configured for the active DL BWP; and
1> if the current symbol n occurs within drx-onDuration Timer duration; and
1> if drx-onDuration Timer associated with the current DRX cycle is not started as specified in this clause; and
1> if the MAC entity would not be in Active Time considering grants/assignments/DRX Command MAC CE/Long DRX Command MAC CE received and Scheduling Request sent until 4 ms prior to symbol n when evaluating all DRX Active Time conditions as specified in this clause:
   2> not transmit periodic SRS and semi-persistent SRS defined in TS 38.214 [7];
   2> not report semi-persistent CSI configured on PUSCH;
   2> if ps-Periodic_CSI_Transmit is not configured with value true:
      3> if ps-TransmitPeriodicLI-RSRP is not configured with value true:
         4> not report periodic CSI on PUCCH.
      3> else:
         4> not report periodic CSI on PUCCH, except L1-RSRP report(s).
1> else:
   2> in current symbol n, if the MAC entity would not be in Active Time considering grants/assignments/DRX Command MAC CE/Long DRX Command MAC CE received and Scheduling Request sent until 4 ms prior to symbol n when evaluating all DRX Active Time conditions as specified in this clause:
      3> not transmit periodic SRS and semi-persistent SRS defined in TS 38.214 [7]:
      3> not report CSI on PUCCH and semi-persistent CSI configured on PUSCH.
   2> if CSI masking (csi-Mask) is setup by upper layers:
      3> in current symbol n, if drx-onDuration Timer would not be running considering grants/assignments/DRX Command MAC CE/Long DRX Command MAC CE received until 4 ms prior to symbol n when evaluating all DRX Active Time conditions as specified in this clause:
         4> not report CSI on PUCCH.
NOTE 3: If a UE multiplexes a CSI configured on PUCCH with other overlapping UCI(s) according to the procedure specified in TS 38.213 [6] clause 9.2.5 and this CSI multiplexed with other UCI(s) would be reported on a PUCCH resource outside DRX Active Time, it is up to UE implementation whether to report this CSI multiplexed with other UCI(s).

Regardless of whether the MAC entity is monitoring PDCCH or not, the MAC entity transmits HARQ feedback, aperiodic CSI on PUSCH, and aperiodic SRS defined in TS 38.214 when such is expected. The MAC entity needs not to monitor the PDCCH if it is not a complete PDCCH occasion (e.g., the Active Time starts or ends in the middle of a PDCCH).

In the following the term eNB/gNB is used for the base station but it is replaceable by any other radio access node, e.g., BS, eNB, gNB, AP, NR etc. Further the proposed methods are described mainly in the context of 5G NR. However, the proposed solutions/methods are also equally applicable to other mobile communication systems supporting serving cells/carriers being configured for Sidelink Communication over PC5 interface.

In the following embodiments, DRX cycle configuration includes a starting offset, on-duration, periodicity, inactivity timer, HARQ retransmission timer, and/or the like.

In the first embodiment, the MAC triggers a plurality of resource (re) selections for transmitting data to Rx UE (or L2 destination) considering a plurality of DRX-timers associated with a DRX configuration where each of the DRX timers e.g., on-duration timer, inactivity timer, or the like, may be provided as an input for the candidate resource selection procedure at different time instances to the physical layer when one of these timers is (re) started. In one embodiment, the input to the PHY as part of the resource (re) selection trigger may contain a DRX configuration e.g., one or more of the timer value(s) negotiated between the Tx and Rx UE for the unicast or the DRX configuration according to a PC5 5G NR Standardized QOS Identifier (“PQI”) for the groupcast/broadcast. In one embodiment, as used herein, an event may be something that happens or occurs that triggers an action, e.g., (re) selection of candidate resources). As described herein, a triggering even that triggers (re) selection of candidate resources may include receiving data, receiving a DRX configuration, receiving a MAC that indicates (re) selection, receiving data at an L2 buffer, starting a timer, expiration of a timer, retransmitting data, the packet delay budget (“PDB”) being outside the active time, and/or the like.

Alternatively, in one embodiment, the timer value is presented as a time window to the PHY layer e.g., [Tₛₜₐᵣₜ, T_{end}]. The DRX configuration may be provided to the PHY as part of the resource (re) selection trigger and the DRX configuration may contain DRX on-duration periods and slot offsets along with other values such as a priority, T₁, T₂ₘᵢₙ/remaining PDB, e.g., as specified in 38.214 mode 2 reselection procedure, and/or the like. Within the PDB or T₂ₘᵢₙ, there could be one or more on-duration timers between the Tx and Rx UE (or L2 destination id) and hence the PHY layer may report a candidate report set that may include a candidate resource spread within one or more on-duration of Rx UE (or L2 destination) until T₂ₘᵢₙ. In another implementation, the candidate resources may be separately reported for each of the DRX-on-duration period and in another implementation, the candidate resources may be reported based on an earliest in time procedure. For example, the candidate resources may be reported for the first DRX on-duration timer: if there are not enough resources, then the candidate resource may be reported from the second DRX on-duration timer, and so on. In another implementation, the DRX configuration e.g., on-duration timer, inactivity timer, or the like, may be provided to the PHY layer by an L2 destination ID by the MAC and a separate resource (re) selection may be triggered to report candidate resources to the PHY layer considering the DRX active time for that destination whenever the new data arrives, or DRX-in-activity timer starts.

In one embodiment, the MAC could select a candidate resource from the reported candidate resources by selecting the candidate resource for transmission and/or reservation within one or more on-duration periods, as shown in FIG. 3. FIG. 3 illustrates candidate resource selection in response to a trigger 302, e.g., reception of a DRX configuration, a MAC entity, or other indication, being received at or prior to an on-duration period 304 of a DRX cycle 306, which triggers candidate resource selection during the on-duration periods 304, 308. In some embodiments, if the PDB 310 falls outside the active time of the UE, then, if the original active time is indicated within the on-duration timer for candidate resource selection, candidate resources could also be reported outside the active time considering that some of the candidate resource partially overlap with that of the active time of the Rx UE.

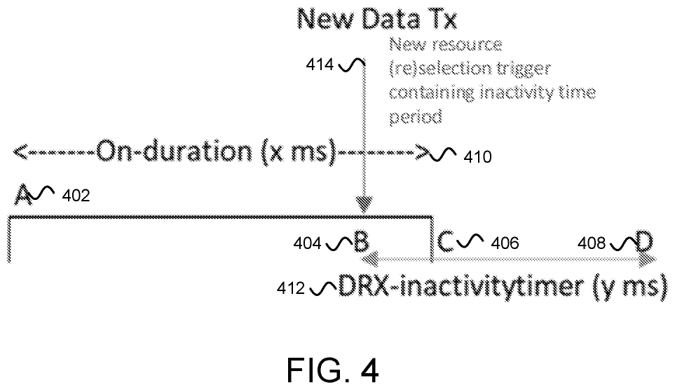

As shown in FIG. 4, if the MAC gives time between A 402 and D 408 to PHY, then PHY might select resources between C 406 and D 408. In FIG. 4, Current Active time=time between points A 402 and C 406 (e.g., the on-duration timer 410) and Future Active time=time between points C 406 and D 408 (e.g., a part of the inactivity timer 412 hanging outside on-duration timer). In one embodiment, when an inactivity timer 412 starts in MAC, a new resource (re) selection 414 is triggered containing the inactivity time. In such an embodiment, the PHY layer could perform candidate resource selection and report candidate resources within the inactivity time period 412.

In one implementation, when the MAC extends (re) starting the inactivity timer, a new resource (re) selection is triggered containing the inactivity time. In such an embodiment the PHY layer reports the selected candidate resources according to that time.

In one embodiment, the PHY layer may not have enough sensing results to report candidate resources within the inactivity time window and hence the trigger may additionally contain a type of sensing that should be performed during the extended active time e.g., inactivity timer is (re) started. In one embodiment, the PHY layer performs full sensing, random sensing, or contiguous partial sensing within Tₐ and T_{b} slots to report candidate resources within the extended active time, where Tₐ and T_{b} could be configured in terms of the time slot and the configuration of the inactivity timer may be greater than the T₁ value, e.g., processing time.

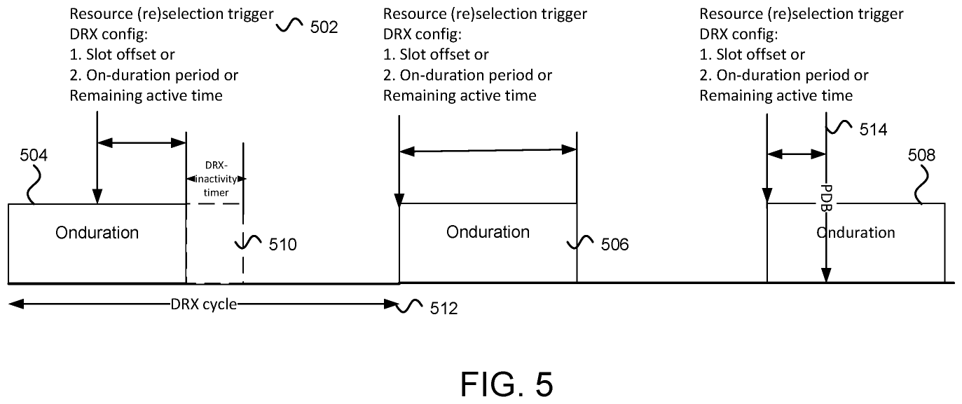

In a second embodiment, shown in FIG. 5, the MAC could trigger 502 resource (re) selection for transmitting data to the Rx UE (or L2 destination) considering each DRX on-duration 504, 506, 508 of a DRX cycle 512. Depending on the data arrival at its L2 buffer, the triggering time could be anywhere within the DRX-on-duration timer 504, 506, 508. The remaining active time is the time instant when the trigger is received at the PHY layer and the end of the DRX on-duration timer 504, 506, 508. In another example, the T₂ₘᵢₙ could be restricted within one or more on-duration period(s) 504, 506, 508 of the UE.

However, in one embodiment, when an inactivity timer starts 510 in MAC, a new resource (re) selection is triggered containing the inactivity timer while PHY layer performs candidate resource selection accordingly for the extended active time due to the inactivity timer, as shown in FIG. 5.

When the new data comes in and before the resource (re) selection trigger is received, the UE checks whether there is enough processing time within the on-duration timer 504, 506, 508, if the remaining time in the on-duration is less than the T₁ (processing time), then the resource (re) selection is not triggered. In another example, the resource (re) selection is triggered; however, the Tx UE could adjust the candidate resource selection window (n+T_{1,n}+T₂ₘᵢₙ) within the next occurrence of the DRX on-duration.

In some embodiments, if the PDB 514 falls outside the active time of the UE, then, if the original active time is indicated within the on-duration timer 504, 506, 508 for candidate resource selection, candidate resources could also be reported outside the active time considering that some of the candidate resource partially overlap with that of the active time of the Rx UE.

In another example, if there are not enough available candidate resources to be reported, then the candidate resources could also be reported outside the active time considering that some of the candidate resource partially overlap with that of the active time of the Rx UE. In another example, if there are not enough available candidate resources to be reported, then the candidate resources could also be reported in the next occurrence of the DRX on-duration time period 504, 506, 508, if PDB 514 allows.

In one embodiment, the first resource (re) selection is triggered when data arrives or is received at the L2 buffer considering an active time equivalent to that of the DRX on-duration time period 504, 506, 508. In such an embodiment, candidate resources are restricted within the active time. In one embodiment, if the PDB 514 falls outside the active time, and when there is not enough candidate resources within the active time, then the candidate resources could also be reported outside the active time considering that some of the candidate resource partially overlap with that of the active time of the Rx UE.

In one embodiment, a second resource (re) selection trigger is started when the inactivity timer starts and new data arrives or is received, retransmission is to be made, or the PDB 514 is outside the active time. Then, in that case, the reported candidate resources include the extended active time caused by (re) starting the inactivity timer, and another active time indicates the next occurrence of the DRX-on-duration, if the PDB 514 allows, and so on, or if the candidate resources within the inactivity timer are not sufficient, then reporting the candidate resources occurs from the next occurrence of the DRX on-duration time period 504, 506, 508 as an additional separate candidate resources.

In another implementation, the first resource (re) selection is triggered when data arrives or is received at the L2 buffer considering active time equivalent to that of the DRX on-duration time period 504, 506, 508. In such an embodiment, Candidate resource is restricted within the active time.

If the PDB 514 falls outside the active time, and when there is not enough candidate resources within the active time, then the candidate resources could also be reported outside the active time as additional separate candidate resources, which may be outside the on-duration timer 504, 506, 508, but still overlap partially or fully with that of the inactivity timer value. In another example, resource (re) selection may include an on-duration timer 504, 506, 508 and an inactivity timer such that separate candidate resources are reported for each of these timers. In one embodiment, the foregoing example could be implemented considering one or more DRX on-duration periods, or the like

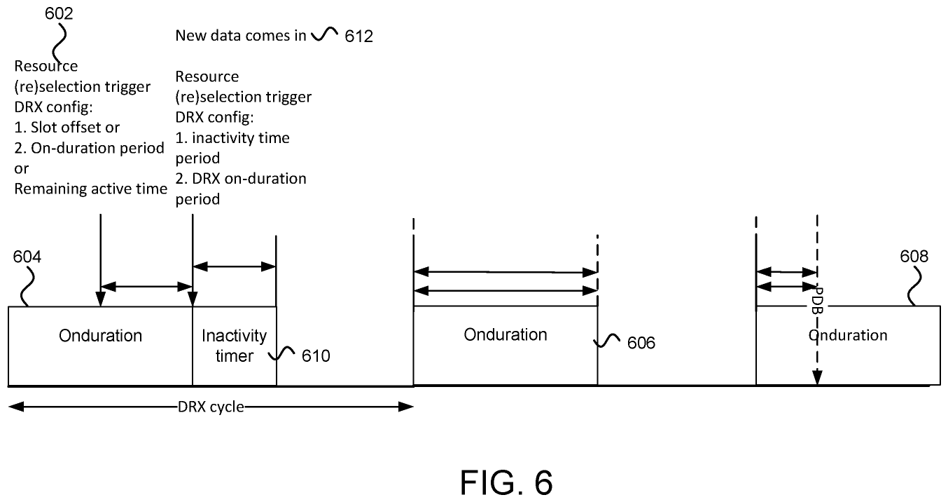

In the third embodiment, the MAC triggers 602 resource (re) selection for transmitting data to a Rx UE (or L2 destination) considering one or more DRX on-duration periods 604, 606, 608. As part of the first resource (re) selection trigger 602, the MAC could provide information to report candidate resources considering one or more DRX on-duration periods 604, 606, 608. However, when an inactivity timer 610 starts in MAC, a new resource (re) selection is triggered 612 that contains a time window of the inactivity timer value and then the next occurrence of the DRX on-duration time period 604 while the PHY layer could perform candidate resource selection accordingly for the extended active timer e.g., an inactivity timer, and then the next occurrence(s) of the DRX on-duration time period(s) 604, 606, 608 to report candidate resources separately, as shown in FIG. 6.

In the fourth embodiment, the DRX-RTT timer value is provided to the PHY layer and the PHY layer of the Tx UE could exclude candidate resources according to the DRX-RTT timer value. The DRX-RTT is started by the Rx UE(s) after transmitting the HARQ-ACK reports to the Tx UE and hence the Tx UE could exclude candidate resources after the physical sidelink feedback channel (“PSFCH’) resource in a resource pool up to the value of the DRX-RTT timer. For example, whenever the PHY layer receives PSFCH feedback from Rx UE during the extended active time e.g., inactivity timer (re) started, the Tx UE excludes candidate resources and does not select resources for transmission when the DRX-RTT timer of the Rx UE is running. In another example, the Tx UE could reselect the already preselected resources that overlap with the Rx UE's DRX-RTT timer when it receives the PSFCH feedback. In another implementation, the Rx UE does not start the DRX-RTT timer when one or more of the resources reserved by a previous sidelink channel information (“SCI”) overlap within that of the DRX-RTT time window.

In another implementation, the DRX-RTT timer value is not provided to the PHY layer, and the MAC of the Tx UE selects resources for transmission such that it excludes the candidate resources after the PSFCH resources in a resource pool up to the value of the DRX-RTT timer. Thus, the MAC of the Tx UE excludes resources overlapping with that of the DRX re-RTT timer value. This embodiment could be implemented together with the above embodiments.

In a fifth embodiment, an inactivity timer is started in the Tx UE after sending a CSI reporting request to the destination. If the Tx UE has data available for transmission in the current DRX cycle periodicity, then a resource (re) selection trigger is sent to the PHY layer immediately after transmitting the CSI request to the destination. The resource reselection trigger itself follows the principles described above.

In a sixth embodiment, the MAC layer selects the one or more resources for the transmission of the PSCCH and/or PSSCH, and informs the PHY layer on these pre-selected resources for resource re-evaluation and pre-emption checking. When the pre-selected resources fall outside the active time of the UE e.g., outside the on-duration time, in one example, the Tx UE continues to start the inactivity timer and performs re-evaluation and pre-emption checking until m-T₃ (e.g., the time window until the resource could be reselected before transmission on the preselected resources). In another example, the Tx UE does not perform re-evaluation and pre-emption checking outside the active time period. For example, when m-T₃ falls outside the active time period, then the Tx UE does not perform re-evaluation and pre-emption checking starting from the end of the active time until m-T₃.

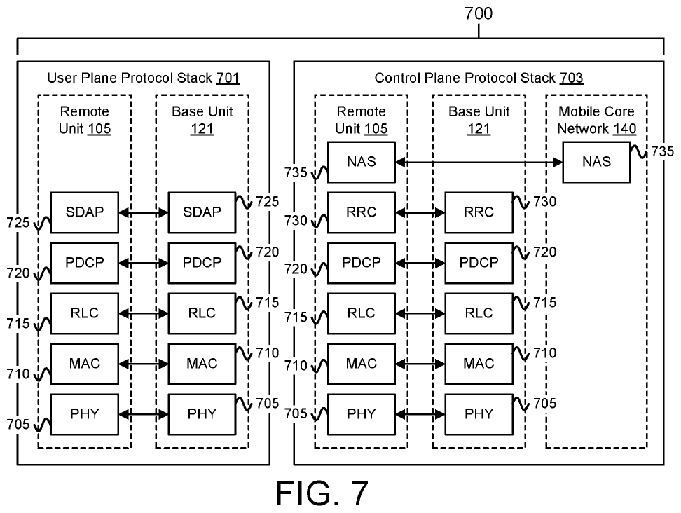

FIG. 7 depicts an NR protocol stack 700, according to embodiments of the disclosure. While FIG. 7 shows the remote unit 105, the base unit 121, and the mobile core network 130, these are representative of a set of UEs interacting with a RAN node and an NF (e.g., AMF) in a core network. As depicted, the NR protocol stack 700 comprises a User Plane protocol stack 701 and a Control Plane protocol stack 703. The User Plane protocol stack 701 includes a PHY layer 705, a Medium Access Control (“MAC”) sublayer 710, a Radio Link Control (“RLC”) sublayer 715, a Packet Data Convergence Protocol (“PDCP”) sublayer 720, and Service Data Adaptation Protocol (“SDAP”) layer 725. The Control Plane protocol stack 703 also includes a PHY layer 705, a MAC sublayer 710, an RLC sublayer 715, and a PDCP sublayer 720. The Control Plane protocol stack 703 also includes a Radio Resource Control (“RRC”) layer 730 and a Non-Access Stratum (“NAS”) layer 735.

The AS protocol stack for the Control Plane protocol stack 703 consists of at least RRC, PDCP, RLC, and MAC sublayers, and the PHY layer. The AS protocol stack for the User Plane protocol stack 701 consists of at least SDAP, PDCP, RLC, and MAC sublayers, and the PHY layer. The Layer-2 (“L2”) is split into the SDAP, PDCP, RLC, and MAC sublayers. The Layer-3 (“L3”) includes the RRC sublayer 730 and the NAS layer 735 for the control plane and includes, for example, an Internet Protocol (“IP”) layer or PDU Layer (not shown) for the user plane. L1 and L2 are referred to as “lower layers” such as PUCCH/PUSCH or MAC-CE, while L3 and above (e.g., transport layer, application layer) are referred to as “higher layers” or “upper layers” such as RRC.

The PHY layer 705 offers transport channels to the MAC sublayer 710. The MAC sublayer 710 offers logical channels to the RLC sublayer 715. The RLC sublayer 715 offers RLC channels to the PDCP sublayer 720. The PDCP sublayer 720 offers radio bearers to the SDAP sublayer 725 and/or RRC layer 730. The SDAP sublayer 725 offers QoS flows to the mobile core network 130 (e.g., 5GC). The RRC layer 730 provides for the addition, modification, and release of Carrier Aggregation and/or Dual Connectivity. The RRC layer 640 also manages the establishment, configuration, maintenance, and release of Signaling Radio Bearers (“SRBs”) and Data Radio Bearers (“DRBs”). In certain embodiments, an RRC entity functions for the detection of and recovery from radio link failure.

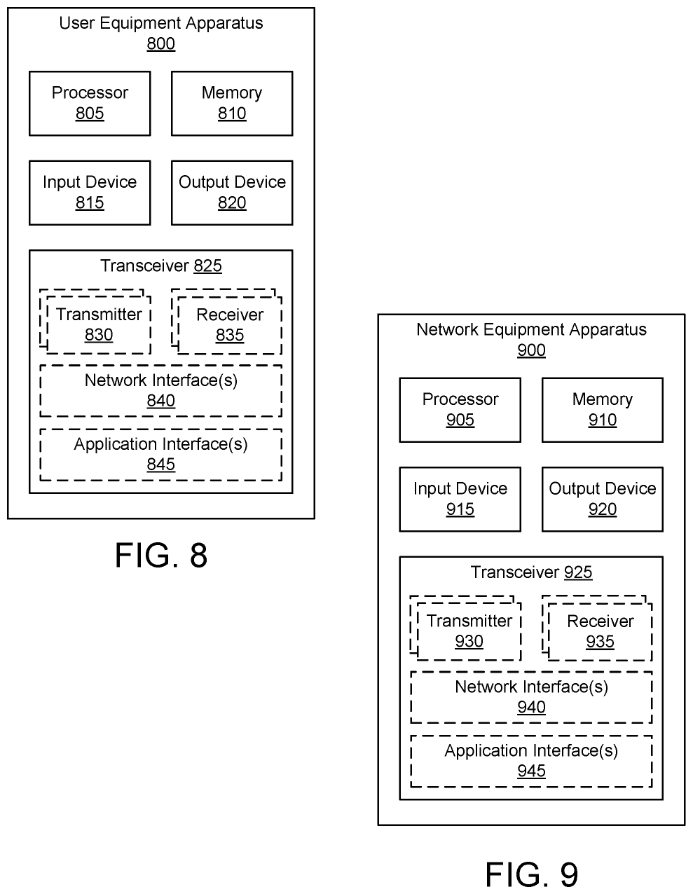

FIG. 8 depicts a UE apparatus 800 that may be used for resource selection considering sidelink DRX, according to embodiments of the disclosure. In various embodiments, the UE apparatus 800 is used to implement one or more of the solutions described above. The UE apparatus 800 may be one embodiment of a UE, such as the remote unit 105 and/or the UE 205, as described above. Furthermore, the UE apparatus 800 may include a processor 805, a memory 810, an input device 815, an output device 820, and a transceiver 825. In some embodiments, the input device 815 and the output device 820 are combined into a single device, such as a touchscreen. In certain embodiments, the UE apparatus 800 may not include the input device 815 and/or the output device 820. In various embodiments, the UE apparatus 800 may include one or more of: the processor 805, the memory 810, and the transceiver 825, and may not include the input device 815 and/or the output device 820.

As depicted, the transceiver 825 includes at least one transmitter 830 and at least one receiver 835. Here, the transceiver 825 communicates with one or more base units 121. Additionally, the transceiver 825 may support at least one network interface 840 and/or application interface 845. The application interface(s) 845 may support one or more APIs. The network interface(s) 840 may support 3GPP reference points, such as Uu and PC5. Other network interfaces 840 may be supported, as understood by one of ordinary skill in the art.

The processor 805, in one embodiment, may include any known controller capable of executing computer-readable instructions and/or capable of performing logical operations. For example, the processor 805 may be a microcontroller, a microprocessor, a central processing unit (“CPU”), a graphics processing unit (“GPU”), an auxiliary processing unit, a field programmable gate array (“FPGA”), a digital signal processor (“DSP”), a co-processor, an application-specific processor, or similar programmable controller. In some embodiments, the processor 805 executes instructions stored in the memory 810 to perform the methods and routines described herein. The processor 805 is communicatively coupled to the memory 810, the input device 815, the output device 820, and the transceiver 825. In certain embodiments, the processor 805 may include an application processor (also known as “main processor”) which manages application-domain and operating system (“OS”) functions and a baseband processor (also known as “baseband radio processor”) which manages radio functions.

The memory 810, in one embodiment, is a computer readable storage medium. In some embodiments, the memory 810 includes volatile computer storage media. For example, the memory 810 may include a RAM, including dynamic RAM (“DRAM”), synchronous dynamic RAM (“SDRAM”), and/or static RAM (“SRAM”). In some embodiments, the memory 810 includes non-volatile computer storage media. For example, the memory 810 may include a hard disk drive, a flash memory, or any other suitable non-volatile computer storage device. In some embodiments, the memory 810 includes both volatile and non-volatile computer storage media.

In some embodiments, the memory 810 stores data related to CSI enhancements for higher frequencies. For example, the memory 810 may store parameters, configurations, resource assignments, policies, and the like as described above. In certain embodiments, the memory 810 also stores program code and related data, such as an operating system or other controller algorithms operating on the UE apparatus 800, and one or more software applications.

The input device 815, in one embodiment, may include any known computer input device including a touch panel, a button, a keyboard, a stylus, a microphone, or the like. In some embodiments, the input device 815 may be integrated with the output device 820, for example, as a touchscreen or similar touch-sensitive display. In some embodiments, the input device 815 includes a touchscreen such that text may be input using a virtual keyboard displayed on the touchscreen and/or by handwriting on the touchscreen. In some embodiments, the input device 815 includes two or more different devices, such as a keyboard and a touch panel.

The output device 820, in one embodiment, is designed to output visual, audible, and/or haptic signals. In some embodiments, the output device 820 includes an electronically controllable display or display device capable of outputting visual data to a user. For example, the output device 820 may include, but is not limited to, an LCD display, an LED display, an OLED display, a projector, or similar display device capable of outputting images, text, or the like to a user. As another, non-limiting, example, the output device 820 may include a wearable display separate from, but communicatively coupled to, the rest of the UE apparatus 800, such as a smart watch, smart glasses, a heads-up display, or the like. Further, the output device 820 may be a component of a smartphone, a personal digital assistant, a television, a table computer, a notebook (laptop) computer, a personal computer, a vehicle dashboard, or the like.

In certain embodiments, the output device 820 includes one or more speakers for producing sound. For example, the output device 820 may produce an audible alert or notification (e.g., a beep or chime). In some embodiments, the output device 820 includes one or more haptic devices for producing vibrations, motion, or other haptic feedback. In some embodiments, all or portions of the output device 820 may be integrated with the input device 815. For example, the input device 815 and output device 820 may form a touchscreen or similar touch-sensitive display. In other embodiments, the output device 820 may be located near the input device 815.

The transceiver 825 includes at least transmitter 830 and at least one receiver 835. The transceiver 825 may be used to provide UL communication signals to a base unit 121 and to receive DL communication signals from the base unit 121, as described herein. Similarly, the transceiver 825 may be used to transmit and receive SL signals (e.g., V2X communication), as described herein. Although only one transmitter 830 and one receiver 835 are illustrated, the UE apparatus 800 may have any suitable number of transmitters 830 and receivers 835. Further, the transmitter(s) 830 and the receiver(s) 835 may be any suitable type of transmitters and receivers. In one embodiment, the transceiver 825 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 825, transmitters 830, and receivers 835 may be implemented as physically separate components that access a shared hardware resource and/or software resource, such as for example, the network interface 840.

In various embodiments, one or more transmitters 830 and/or one or more receivers 835 may be implemented and/or integrated into a single hardware component, such as a multi-transceiver chip, a system-on-a-chip, an ASIC, or other type of hardware component. In certain embodiments, one or more transmitters 830 and/or one or more receivers 835 may be implemented and/or integrated into a multi-chip module. In some embodiments, other components such as the network interface 840 or other hardware components/circuits may be integrated with any number of transmitters 830 and/or receivers 835 into a single chip. In such embodiment, the transmitters 830 and receivers 835 may be logically configured as a transceiver 825 that uses one more common control signals or as modular transmitters 830 and receivers 835 implemented in the same hardware chip or in a multi-chip module.

In one embodiment, the processor 805 is configured to determine an event triggering a resource reselection to perform candidate resource selection from a resource pool according to a DRX timer. In one embodiment, the processor 805 is configured to select, in response to the event triggering the resource reselection, a first candidate resource from the resource pool during an active duration of the apparatus associated with the DRX timer and a second candidate resource from the resource pool during an inactive duration of the apparatus associated with the DRX timer. In one embodiment, the processor 805 is configured to transmit a report indicating the first candidate resource and the second candidate resource.

In one embodiment, the DRX timer comprises a DRX on-duration timer or a DRX inactivity timer.

In one embodiment, the processor 805 is configured to receive data at an L2 buffer, in response to the active duration of the apparatus being equivalent to a period of the DRX on-duration timer, and wherein to select the first candidate resource is triggered in response to the received data at the L2 buffer.

In one embodiment, the processor 805 is configured to determine, prior to the determined resource reselection trigger event, a duration associated with the DRX timer.

In one embodiment, in response to the duration associated with the DRX timer being less than a threshold, the processor is configured to adjust a candidate resource selection time window for a subsequent occasion of the DRX timer.

In one embodiment, the processor 805 is configured to select the second candidate resource outside the active duration of the apparatus in response to a packet delay budget being outside the active duration of the apparatus and an original active duration of the apparatus indicated within the DRX timer for candidate resource selection.

In one embodiment, the processor 805 is configured to transmit the report outside the active duration of the apparatus in response to a quantity of candidate resources in the resource pool being below a threshold.

In one embodiment, the processor 805 is configured to transmit the report in a next occurrence of the DRX timer in response to a quantity of candidate resources in the resource pool being below a threshold.

In one embodiment, resource reselection is triggered for receiving data at the apparatus in response to a receiving a MAC entity at a MAC layer, the MAC entity comprising a DRX configuration for the DRX timer.

In one embodiment, the DRX configuration is received at the PHY layer, the DRX configuration comprising DRX on-duration timer periods and slot offset values.

In one embodiment, the processor 805 is configured to select, by the MAC layer, the first or second candidate resources for transmission of PSCCH, PSSCH, or a combination of both and inform PHY of the selected resources for resource reevaluation and preemption checking.

In one embodiment, in response to the selected resources falling outside the active duration of the apparatus, the processor 805 is configured to perform resource reevaluation and preemption checking for the selected resources until a time window where the selected resources can be reselected prior to transmission on the selected resources.

FIG. 9 depicts one embodiment of a network equipment apparatus 900 that may be used for resource selection considering sidelink DRX, according to embodiments of the disclosure. In some embodiments, the network equipment apparatus 900 may be one embodiment of a RAN node and its supporting hardware, such as the base unit 121, described above. Furthermore, network equipment apparatus 900 may include a processor 905, a memory 910, an input device 915, an output device 920, and a transceiver 925. In certain embodiments, the network equipment apparatus 900 does not include any input device 915 and/or output device 920.

As depicted, the transceiver 925 includes at least one transmitter 930 and at least one receiver 935. Here, the transceiver 925 communicates with one or more remote units 105. Additionally, the transceiver 925 may support at least one network interface 940 and/or application interface 945. The application interface(s) 945 may support one or more APIs. The network interface(s) 940 may support 3GPP reference points, such as Uu, N1, N2, N3, N5, N6 and/or N7 interfaces. Other network interfaces 940 may be supported, as understood by one of ordinary skill in the art.

The processor 905, in one embodiment, may include any known controller capable of executing computer-readable instructions and/or capable of performing logical operations. For example, the processor 905 may be a microcontroller, a microprocessor, a CPU, a GPU, an auxiliary processing unit, an FPGA, a DSP, a co-processor, an application-specific processor, or similar programmable controller. In some embodiments, the processor 905 executes instructions stored in the memory 910 to perform the methods and routines described herein. The processor 905 is communicatively coupled to the memory 910, the input device 915, the output device 920, and the transceiver 925. In certain embodiments, the processor 905 may include an application processor (also known as “main processor”) which manages application-domain and OS functions and a baseband processor (also known as “baseband radio processor”) which manages radio function. In various embodiments, the processor 905 controls the network apparatus 900 to implement the above described network entity behaviors (e.g., of the gNB) for resource selection considering sidelink DRX.

The memory 910, in one embodiment, is a computer readable storage medium. In some embodiments, the memory 910 includes volatile computer storage media. For example, the memory 910 may include a RAM, including DRAM, SDRAM, and/or SRAM. In some embodiments, the memory 910 includes non-volatile computer storage media. For example, the memory 910 may include a hard disk drive, a flash memory, or any other suitable non-volatile computer storage device. In some embodiments, the memory 910 includes both volatile and non-volatile computer storage media.

In some embodiments, the memory 910 stores data relating to resource selection considering sidelink DRX. For example, the memory 910 may store parameters, configurations, resource assignments, policies, and the like as described above. In certain embodiments, the memory 910 also stores program code and related data, such as an operating system (“OS”) or other controller algorithms operating on the network equipment apparatus 900, and one or more software applications.

The input device 915, in one embodiment, may include any known computer input device including a touch panel, a button, a keyboard, a stylus, a microphone, or the like. In some embodiments, the input device 915 may be integrated with the output device 920, for example, as a touchscreen or similar touch-sensitive display. In some embodiments, the input device 915 includes a touchscreen such that text may be input using a virtual keyboard displayed on the touchscreen and/or by handwriting on the touchscreen. In some embodiments, the input device 915 includes two or more different devices, such as a keyboard and a touch panel.

The output device 920, in one embodiment, may include any known electronically controllable display or display device. The output device 920 may be designed to output visual, audible, and/or haptic signals. In some embodiments, the output device 920 includes an electronic display capable of outputting visual data to a user. Further, the output device 920 may be a component of a smart phone, a personal digital assistant, a television, a table computer, a notebook (laptop) computer, a personal computer, a vehicle dashboard, or the like.

In certain embodiments, the output device 920 includes one or more speakers for producing sound. For example, the output device 920 may produce an audible alert or notification (e.g., a beep or chime). In some embodiments, the output device 920 includes one or more haptic devices for producing vibrations, motion, or other haptic feedback. In some embodiments, all or portions of the output device 920 may be integrated with the input device 915. For example, the input device 915 and output device 920 may form a touchscreen or similar touch-sensitive display. In other embodiments, all or portions of the output device 920 may be located near the input device 915.

As discussed above, the transceiver 925 may communicate with one or more remote units and/or with one or more interworking functions that provide access to one or more PLMNs. The transceiver 925 may also communicate with one or more network functions (e.g., in the mobile core network 80). The transceiver 925 operates under the control of the processor 905 to transmit messages, data, and other signals and also to receive messages, data, and other signals. For example, the processor 905 may selectively activate the transceiver (or portions thereof) at particular times in order to send and receive messages.

The transceiver 925 may include one or more transmitters 930 and one or more receivers 935. In certain embodiments, the one or more transmitters 930 and/or the one or more receivers 935 may share transceiver hardware and/or circuitry. For example, the one or more transmitters 930 and/or the one or more receivers 935 may share antenna(s), antenna tuner(s), amplifier(s), filter(s), oscillator(s), mixer(s), modulator/demodulator(s), power supply, and the like. In one embodiment, the transceiver 925 implements multiple logical transceivers using different communication protocols or protocol stacks, while using common physical hardware.

In one embodiment, the processor 905 is configured to transmit, to a UE, a resource reselection trigger to perform candidate resource selection from a resource pool according to a DRX timer. In one embodiment, the processor 905 is configured to receive a report comprising a selection of a first and second selected candidate resources selected from the resource pool, the first candidate resource selected during an active duration of the UE associated with the DRX timer, and the second candidate resource selected pool during an inactive duration of the UE associated with the DRX timer.

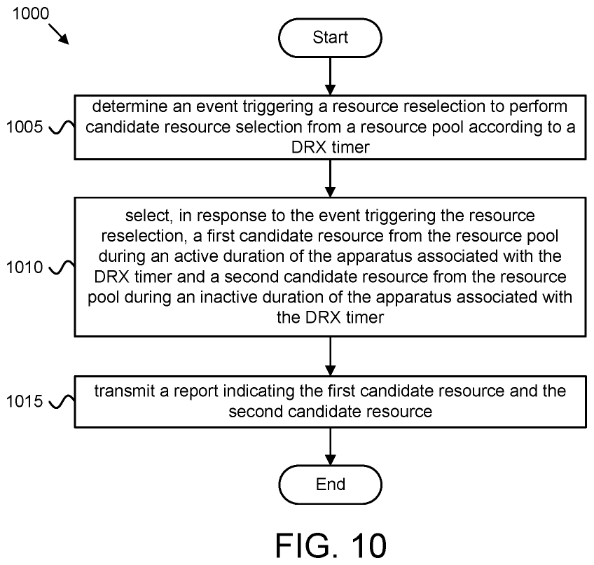

FIG. 10 is a flowchart diagram of a method 1000 for resource selection considering sidelink DRX. The method 1000 may be performed by a UE as described herein, for example, the remote unit 105 and/or the UE apparatus 800. In some embodiments, the method 1000 may be performed by a processor executing program code, for example, a microcontroller, a microprocessor, a CPU, a GPU, an auxiliary processing unit, a FPGA, or the like.

In one embodiment, the method 1000 begins and determines 1005 an event triggering a resource reselection to perform candidate resource selection from a resource pool according to a DRX timer. In one embodiment, the method 1000 selects 1010, in response to the event triggering the resource reselection, a first candidate resource from the resource pool during an active duration of the apparatus associated with the DRX timer and a second candidate resource from the resource pool during an inactive duration of the apparatus associated with the DRX timer. In one embodiment, the method 1000 transmits 1015 a report indicating the first candidate resource and the second candidate resource, and the method 1000 ends.

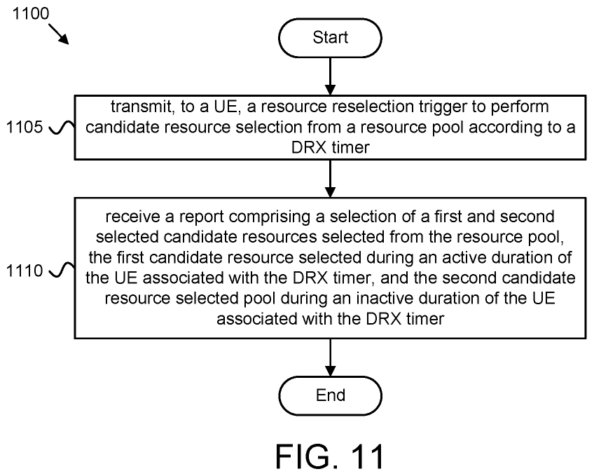

FIG. 11 is a flowchart diagram of a method 1100 for resource selection considering sidelink DRX. The method 1100 may be performed by a network device as described herein, for example, the base unit 121, and/or the network equipment apparatus 800. In some embodiments, the method 1100 may be performed by a processor executing program code, for example, a microcontroller, a microprocessor, a CPU, a GPU, an auxiliary processing unit, a FPGA, or the like.

In one embodiment, the method 1100 begins and transmits 1105, to a UE, a resource reselection trigger to perform candidate resource selection from a resource pool according to a DRX timer. In one embodiment, the method 1100 receives 1110 a report comprising a selection of a first and second selected candidate resources selected from the resource pool, the first candidate resource selected during an active duration of the UE associated with the DRX timer, and the second candidate resource selected pool during an inactive duration of the UE associated with the DRX timer, and the method 1100 ends.

A first apparatus is disclosed for resource selection considering sidelink DRX. The first apparatus may include a UE as described herein, for example, the remote unit 105 and/or the UE apparatus 800. In some embodiments, the first apparatus includes a processor executing program code, for example, a microcontroller, a microprocessor, a CPU, a GPU, an auxiliary processing unit, a FPGA, or the like.

In one embodiment, the first apparatus includes a memory and a processor coupled to the memory. In one embodiment, the processor is configured to cause the apparatus to determine an event triggering a resource reselection to perform candidate resource selection from a resource pool according to a DRX timer. In one embodiment, the processor is configured to cause the apparatus to select, in response to the event triggering the resource reselection, a first candidate resource from the resource pool during an active duration of the apparatus associated with the DRX timer and a second candidate resource from the resource pool during an inactive duration of the apparatus associated with the DRX timer. In one embodiment, the processor is configured to cause the apparatus to transmit a report indicating the first candidate resource and the second candidate resource.

In one embodiment, the DRX timer comprises a DRX on-duration timer or a DRX inactivity timer.

In one embodiment, the processor is configured to cause the apparatus to receive data at an L2 buffer, in response to the active duration of the apparatus being equivalent to a period of the DRX on-duration timer, and wherein to select the first candidate resource is triggered in response to the received data at the L2 buffer.

In one embodiment, the processor is configured to determine, prior to the determined resource reselection trigger event, a duration associated with the DRX timer.

In one embodiment, in response to the duration associated with the DRX timer being less than a threshold, the processor is configured to adjust a candidate resource selection time window for a subsequent occasion of the DRX timer.

In one embodiment, the processor is configured to cause the apparatus to select the second candidate resource outside the active duration of the apparatus in response to a packet delay budget being outside the active duration of the apparatus and an original active duration of the apparatus indicated within the DRX timer for candidate resource selection.

In one embodiment, the processor is configured to cause the apparatus to transmit the report outside the active duration of the apparatus in response to a quantity of candidate resources in the resource pool being below a threshold.

In one embodiment, the processor is configured to cause the apparatus to transmit the report in a next occurrence of the DRX timer in response to a quantity of candidate resources in the resource pool being below a threshold.

In one embodiment, resource reselection is triggered for receiving data at the apparatus in response to a receiving a MAC entity at a MAC layer, the MAC entity comprising a DRX configuration for the DRX timer.

In one embodiment, the DRX configuration is received at the PHY layer, the DRX configuration comprising DRX on-duration timer periods and slot offset values.

In one embodiment, the processor is configured to select, by the MAC layer, the first or second candidate resources for transmission of PSCCH, PSSCH, or a combination of both and inform PHY of the selected resources for resource reevaluation and preemption checking.

In one embodiment, in response to the selected resources falling outside the active duration of the apparatus, the processor is configured to perform resource reevaluation and preemption checking for the selected resources until a time window where the selected resources can be reselected prior to transmission on the selected resources.

A first method is disclosed for resource selection considering sidelink DRX. The first method may be performed by a UE as described herein, for example, the remote unit 105 and/or the UE apparatus 800. In some embodiments, the first method may be performed by a processor executing program code, for example, a microcontroller, a microprocessor, a CPU, a GPU, an auxiliary processing unit, a FPGA, or the like.

In one embodiment, the first method determines, at a UE, an event triggering a resource reselection to perform candidate resource selection from a resource pool according to a DRX timer. In one embodiment, the first method selects, in response to the event triggering the resource reselection, a first candidate resource from the resource pool during an active duration of the UE associated with the DRX timer and a second candidate resource from the resource pool during an inactive duration of the UE associated with the DRX timer. In one embodiment, the first method transmits a report indicating the first candidate resource and the second candidate resource.

In one embodiment, the DRX timer comprises a DRX on-duration timer or a DRX inactivity timer.

In one embodiment, the first method receives data at an L2 buffer, in response to the active duration of the UE being equivalent to a period of the DRX on-duration timer, and wherein to select the first candidate resource is triggered in response to the received data at the L2 buffer.

In one embodiment, the first method determines, prior to the determined resource reselection trigger event, a duration associated with the DRX timer.

In one embodiment, in response to the duration associated with the DRX timer being less than a threshold, the first method adjusts a candidate resource selection time window for a subsequent occasion of the DRX timer.

In one embodiment, the first method selects the second candidate resource outside the active duration of the UE in response to a packet delay budget being outside the active duration of the UE and an original active duration of the UE indicated within the DRX timer for candidate resource selection.

In one embodiment, the first method transmits the report outside the active duration of the UE in response to a quantity of candidate resources in the resource pool being below a threshold.

In one embodiment, the first method transmits the report in a next occurrence of the DRX timer in response to a quantity of candidate resources in the resource pool being below a threshold.

In one embodiment, resource reselection is triggered for receiving data at the UE in response to a receiving a MAC entity at a MAC layer, the MAC entity comprising a DRX configuration for the DRX timer.

In one embodiment, the DRX configuration is received at the PHY layer, the DRX configuration comprising DRX on-duration timer periods and slot offset values.

In one embodiment, the first method selects, by the MAC layer, the first or second candidate resources for transmission of PSCCH, PSSCH, or a combination of both and inform PHY of the selected resources for resource reevaluation and preemption checking.

In one embodiment, in response to the selected resources falling outside the active duration of the UE, the first method performs resource reevaluation and preemption checking for the selected resources until a time window where the selected resources can be reselected prior to transmission on the selected resources.

A second apparatus is disclosed for resource selection considering sidelink DRX. The second apparatus may include a UE as described herein, for example, the base unit 121, the gNB, and/or the network equipment apparatus 900. In some embodiments, the second apparatus includes a processor executing program code, for example, a microcontroller, a microprocessor, a CPU, a GPU, an auxiliary processing unit, a FPGA, or the like.

In one embodiment, the second apparatus includes a memory and a processor coupled to the memory. In one embodiment, the processor is configured to cause the apparatus to transmit, to a UE, a resource reselection trigger to perform candidate resource selection from a resource pool according to a DRX timer. In one embodiment, the processor is configured to cause the apparatus to receive a report comprising a selection of a first and second selected candidate resources selected from the resource pool, the first candidate resource selected during an active duration of the UE associated with the DRX timer, and the second candidate resource selected pool during an inactive duration of the UE associated with the DRX timer.

A second method is disclosed for resource selection considering sidelink DRX. The second method may be performed by a network device as described herein, for example, the base unit 121, the gNB, and/or the network equipment apparatus 900. In some embodiments, the second method may be performed by a processor executing program code, for example, a microcontroller, a microprocessor, a CPU, a GPU, an auxiliary processing unit, a FPGA, or the like.

In one embodiment, the second method transmits, to a UE, a resource reselection trigger to perform candidate resource selection from a resource pool according to a DRX timer. In one embodiment, the second method receives a report comprising a selection of a first and second selected candidate resources selected from the resource pool, the first candidate resource selected during an active duration of the UE associated with the DRX timer, and the second candidate resource selected pool during an inactive duration of the UE associated with the DRX timer.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus, comprising:
a memory; and
a processor coupled to the memory, the processor configured to cause the apparatus to:
determine an event triggering a resource reselection to perform candidate resource selection from a resource pool according to a discontinuous reception (“DRX”) timer;
select, in response to the event triggering the resource reselection:
a first candidate resource from the resource pool during an active duration of the apparatus associated with the DRX timer; and
a second candidate resource from the resource pool during an inactive duration of the apparatus associated with the DRX timer; and
transmit a report indicating the first candidate resource and the second candidate resource.

2. The apparatus of claim 1, wherein the DRX timer comprises a DRX on-duration timer or a DRX inactivity timer.

3. The apparatus of claim 2, wherein the processor is configured to cause the apparatus to receive data at a layer 2 (“L2”) buffer, in response to the active duration of the apparatus being equivalent to a period of the DRX on-duration timer, and wherein to select the first candidate resource is triggered in response to the received data at the L2 buffer.

4. The apparatus of claim 1, wherein the processor is configured to determine, prior to the determined resource reselection trigger event, a duration associated with the DRX timer.

5. The apparatus of claim 4, wherein, in response to the duration associated with the DRX timer being less than a threshold, the processor is configured to ignore the resource reselection trigger.

6. The apparatus of claim 4, wherein, in response to the duration associated with the DRX timer being less than a threshold, the processor is configured to adjust a candidate resource selection time window for a subsequent occasion of the DRX timer.

7. The apparatus of claim 1, wherein the processor is configured to cause the apparatus to select the second candidate resource outside the active duration of the apparatus in response to a packet delay budget being outside the active duration of the apparatus and an original active duration of the apparatus indicated within the DRX timer for candidate resource selection.

8. The apparatus of claim 1, wherein the processor is configured to cause the apparatus to transmit the report outside the active duration of the apparatus in response to a quantity of candidate resources in the resource pool being below a threshold.

9. The apparatus of claim 1, wherein the processor is configured to cause the apparatus to transmit the report in a next occurrence of the DRX timer in response to a quantity of candidate resources in the resource pool being below a threshold.

10. The apparatus of claim 1, wherein resource reselection is triggered for receiving data at the apparatus in response to a receiving a medium access control (“MAC”) entity at a MAC layer, the MAC entity comprising a DRX configuration for the DRX timer.

11. The apparatus of claim 10, wherein the DRX configuration is received at the PHY layer, the DRX configuration comprising DRX on-duration timer periods and slot offset values.

12. The apparatus of claim 10, wherein the processor is configured to select, by the MAC layer, the first or second candidate resources for transmission of physical shared control channel (“PSCCH”), physical shared sidelink channel (“PSSCH”), or a combination of both and inform PHY of the selected resources for resource reevaluation and preemption checking.

13. The apparatus of claim 12, wherein, in response to the selected resources falling outside the active duration of the apparatus, the processor is configured to perform resource reevaluation and preemption checking for the selected resources until a time window where the selected resources can be reselected prior to transmission on the selected resources.

14. A method, comprising:
determining, at a user equipment (“UE”), an event triggering a resource reselection to perform candidate resource selection from a resource pool according to a discontinuous reception (“DRX”) timer;
selecting, in response to the event triggering the resource reselection:
a first candidate resource from the resource pool during an active duration of the UE associated with the DRX timer; and
a second candidate resource from the resource pool during an inactive duration of the UE associated with the DRX timer; and
transmitting a report indicating the first candidate resource and the second candidate resource.

15. An apparatus, comprising:
a memory; and
a processor coupled to the memory, the processor configured to cause the apparatus to:
transmit, to a user equipment (“UE”), a resource reselection trigger to perform candidate resource selection from a resource pool according to a discontinuous reception (“DRX”) timer; and
receive a report comprising a selection of a first and second selected candidate resources selected from the resource pool, the first candidate resource selected during an active duration of the UE associated with the DRX timer, and the second candidate resource selected pool during an inactive duration of the UE associated with the DRX timer.
